(19) United States
(12) Patent Application Publication
(10) Pub. No.: US 2014/0231378 A1
(43) Pub. Date: Aug. 21, 2014

(54) ACCESSORY FOR A FEEDING BOTTLE

(71) Applicant: Peter Roos, Saltsjo-Boo (SE)

(72) Inventor: Peter Roos, Saltsjo-Boo (SE)

(21) Appl. No.: 14/347,755

(22) PCT Filed: Jun. 12, 2012
(86) PCT No.: PCT/SE2012/000091

§ 371 Date: Mar. 27, 2014

(51) Int. Cl. A61J 9/00

(52) U.S. Cl. CPC A61J 9/00
USPC 215/387

(57) ABSTRACT

An accessory for a feeding bottle (F) includes an insert (1) that is generally conical and intended to be mounted in the opening of the feeding bottle (F). The accessory is distinguished in that the envelope surface of the insert (1) is defined by mutually crossing ribs (5, 7) that form a grid.

### TECHNICAL FIELD OF THE INVENTION

The present invention refers to an accessory for a feeding bottle, which accessory is generally conical and intended to be mounted in the opening of the feeding bottle.

### STATE OF THE ART

A filtering device for powdered milk is known from KR100802646B, in which the filtering device is mounted in the opening of a feeding bottle. The filtering device comprises a filter basket and a holder that supports the filter basket. The filter basket comprises a filter net that captures metal particles in the dried milk powder.

A filter insert for a feeding bottle is known from CN2642304Y, in which the insert generally has the shape of a truncated cone that is provided with openings. The cone has a bottom that is also provided with holes. The insert is mounted in the opening of the feeding bottle.

### OBJECTS AND FEATURES OF THE INVENTION

One primary object of the present invention is to describe an accessory of the type defined above that will prevent the formation of lumps when powdered formula is mixed with water.

An additional object of the present invention is that the accessory must not negatively affect the outflow of baby formula through the nipple for a user of the feeding bottle.

Yet another object of the present invention is that the accessory must be easy to mount in/remove from a feeding bottle.

Yet another object of the present invention is that the accessory can be mounted in a plurality of feeding bottles available on the market.

At least the primary object of the present invention is realized by means of a device that has been given the features specified in independent claim 1 below. Preferred embodiments of the invention are defined in the dependent claims.

### BRIEF DESCRIPTION OF THE DRAWINGS

Preferred embodiments of the invention will be described below with reference to the accompanying drawings, wherein:

FIG. 1 shows a perspective view of a first embodiment of an accessory according to the present invention;

FIG. 1A shows an end view of the embodiment according to FIG. 1;

FIG. 2 schematically shows how the accessory according to FIG. 1 is arranged during its mounting in a feeding bottle;

FIG. 3 schematically shows how the accessory according to FIG. 1 is finally mounted in a feeding bottle;

FIG. 4 shows a perspective view of a second embodiment of an accessory according to the present invention;

FIG. 5 shows a perspective view of a third embodiment of an accessory according to the present invention;

FIG. 6 shows a perspective view of a fourth embodiment of an accessory according to the present invention; and

FIG. 7A—

FIG. 7F show examples of various cross-sections of the ribs that define the envelope surface of the accessory.

### DETAILED DESCRIPTION OF PREFERRED EMBODIMENTS OF THE INVENTION

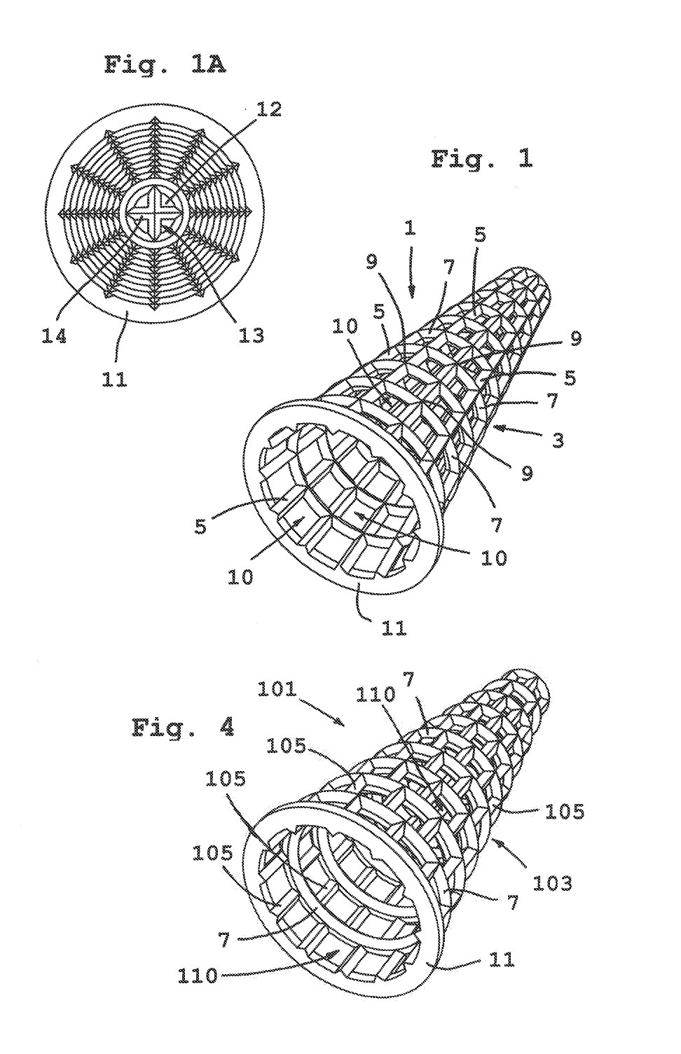

The accessory according to the present invention shown in FIG. 1 represents a first embodiment. The accessory consists of a generally conical insert 1, which is intended to be removably mounted in a feeding bottle. This will be illustrated below.

As FIG. 1 shows, the envelope surface 3 of the insert 1 is designed as a grid, which grid comprises a first set of linear first ribs 5 extending in the longitudinal direction of the insert and a second set of annular second ribs 7 extending in the circumferential direction of the insert 1. Each and every one of the linear first ribs 5 extends along the entire longitudinal direction of the insert 1, and each and every one of the annular second ribs 7 extends along the entire circumference of the insert 1. Because the insert 1 is conical, the lengths of the annular second ribs 7 will vary.

The first ribs 5 and the second ribs 7 cross one another to form nodes 9, whereupon the first ribs 5 and the second ribs 7 generally intersect at right angles to one another in the nodes 9. As FIG. 1 shows, the insert comprises a number of openings 10 that are defined by two opposing sections of two adjacent linear first ribs 5 and two opposing sections of two adjacent annular second ribs 7. The conicity of the insert 1 also entails that each opening 10 has the shape of a trapezoid.

Regarding the cross-sectional shape of the linear first ribs 5 and the annular second ribs 7, it is square in the embodiment of the insert 1 shown in FIG. 1. In this context it must be pointed out that in the embodiment according to FIG. 1, the first and second ribs 5 and 7, respectively, are oriented in such a way that one corner of the square is turned outward, i.e. a pointed longitudinal edge of each and every one of the linear first ribs 5 and a pointed circumferential edge of each and every one of the annular second ribs 7 impart to the insert according to the present invention important properties that will be described in greater detail below.

An annular collar 11 that performs an important function in connection with the mounting of the insert 1 in a feeding bottle is arranged at the end of the insert 1 having the greater diameter.

A cruciform 13 consisting of two third ribs 14 that cross one another at right angles is arranged at the end 12 of the insert having the lesser diameter. The third ribs 14 preferably have cross-sections corresponding to the first and second ribs 5 and 7, respectively.

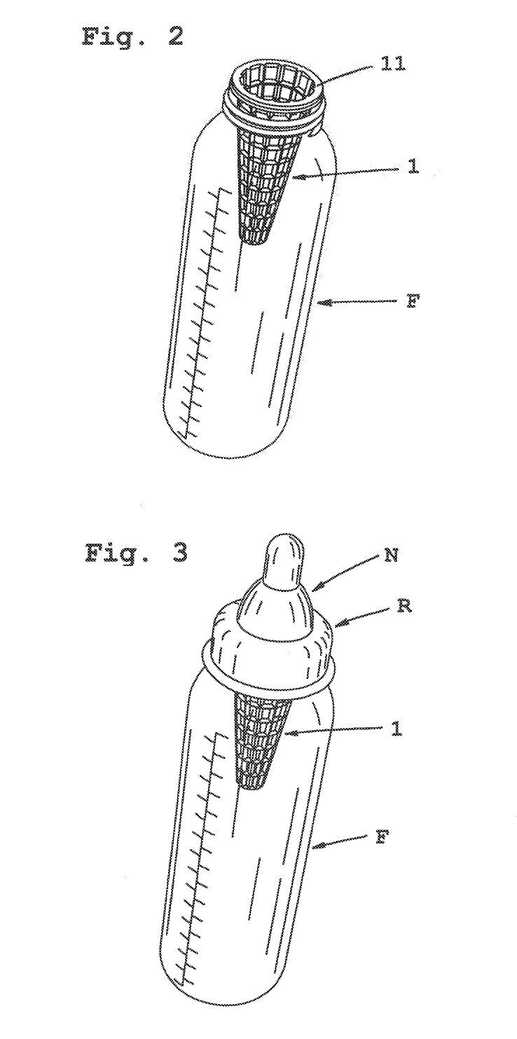

FIG. 2 shows how the insert according to FIG. 1 is arranged in the opening of a feeding bottle F, whereupon the collar 11 of the insert 1 comes in abutment to the edge of the opening of the feeding bottle F. The feeding bottle F has an outward thread G in the connection to the opening.

By means of screwing on a ring R with an inward thread, see FIG. 3, the collar 11 of the insert 1 is locked securely between the opening and the ring R. A nipple N is received in a hole in the ring R. As FIGS. 2 and 3 show, the insert 1 extends a distance down into the feeding bottle F, with the insert 1 in the embodiment shown having an extent in the vertical direction of the feeding bottle that corresponds to approximately half the height of the feeding bottle.

When the insert 1 according to the present invention is used, water and powdered formula are first mixed in the feeding bottle in the usual way. The insert 1 is then mounted in the manner illustrated in FIGS. 2 and 3, i.e. the collar 11 of the insert 1 is clamped securely between the opening of the feeding bottle F and the inwardly threaded ring R. A feeding bottle F with a removably mounted insert according to FIG. 2 is thereby achieved.

The user now shakes the feeding bottle F, with the insert 1, whereupon the feeding bottle F is preferably moved in a back-and-forth motion in its longitudinal direction. The contents of the feeding bottle F, i.e. the mixture of water and powdered formula, will thus also be brought into a back-and-forth motion in the longitudinal direction of the feeding bottle F. Because of the mass inertia of the mixture, it will not move synchronously with the feeding bottle F, but rather a certain lag will occur. This means that the mixture of water and powdered formula will move relative to the insert 1. The external structure of the insert 1, i.e. the pointed edges of the ribs 5 and 7, will thus promote the mixing of the powdered formula in the water in an effective manner without undesirable lumps arising.

FIG. 4 shows a second embodiment of an accessory according to the present invention, wherein the accessory consists of a generally conical insert 101. As FIG. 4 shows, the envelope surface 103 of the insert 101 is designed as a grid, which grid comprises a first set of linear first ribs 105 extending in the longitudinal direction of the insert 101 and a second set of annular second ribs 7 extending in the circumferential direction of the insert 101, which second ribs correspond in principle to the second ribs 7 in the embodiment according, to FIG. 1. For this reason, the second ribs have been assigned the same reference designation, 7, in both embodiments.

The linear first ribs 105 have a significantly shorter length than the linear first ribs 5 in the embodiment according to FIG. 1. The linear first ribs 105 thus extend only between adjacent second annular ribs 7. The linear first ribs 105 in two adjacent levels are thus displaced relative to one another laterally.

Each and every one of the annular second ribs 7 extends along the entire circumference of the insert 101. Because the insert 101 is conical, the lengths of the annular second ribs 7 will vary.

The first ribs 105 and the second ribs 7 cross one another to form nodes 109, wherein the first ribs 105 and the second ribs 7 generally form right angles to one another in the nodes 109. It must be noted in this context that a first rib 105 intersects a second rib 7 in the nodes 109. As FIG. 4 shows, the insert 101 comprises a number of openings 110 that are defined by two adjacent linear first ribs 105 and two opposing sections of two adjacent annular second ribs 7. The conicity of the insert 101 entails that each opening 110 also has the shape of a trapezoid.

Regarding the cross-sectional shape of the linear first ribs 105 and the annular second ribs 7, it is square in the embodiment of the insert 101 shown in FIG. 4. In this context it must be pointed out that the first and second ribs 105 and 7, respectively, in the embodiment according to FIG. 4 are oriented so that one corner of the square is turned outward, i.e. a pointed longitudinal edge of each and every one of the linear first ribs 105 and a pointed circumferential edge of each and every one of the annular second ribs 7 impart important properties to the insert 101 according to the present invention. Because these properties are the same as in the embodiment according to FIG. 1., please refer to the description associated with that embodiment with regard to the function of the insert 101.

An annular collar 11 that performs an important function in connection with the mounting of the insert 1 [sic] in a feeding bottle is arranged at the end of the insert 101 having the greater diameter. Because the collars 11 in the embodiments according to FIGS. 1 and 4 are identical in principle, they have been assigned the same reference designation.

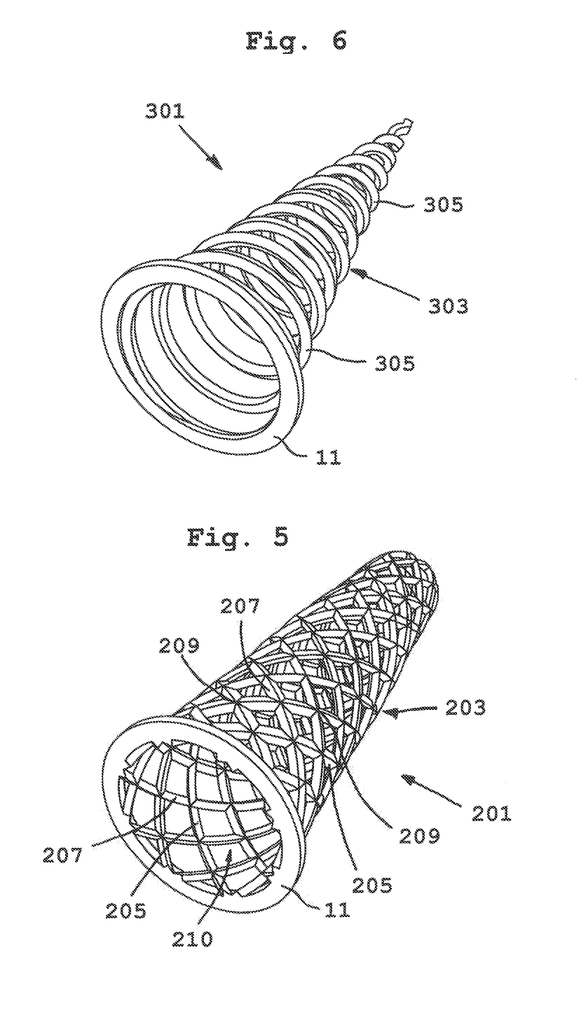

FIG. 5 shows a third embodiment of an accessory according to the present invention, wherein the accessory consists of a generally conical insert 201. As FIG. 5 shows, the envelope surface 203 of the insert 201 is designed as a grid, which grid comprises a first set of first ribs 205 that have a conical helical shape and a second set of second ribs 207 that have a conical helical shape. The first set of first ribs 205 defines a right-handed helix running in the direction from the end with the greater diameter toward the end with the lesser diameter, while the second set of second ribs 207 defines a left-handed helix running in the direction from the end with the greater diameter toward the end with the lesser diameter.

The first set of first ribs 205 and the second set of second ribs 207 cross one another to form nodes 209, wherein the first set of first ribs 205 and the second set of second ribs 207 generally form right angles to one another in the nodes 209. As FIG. 5 shows, the insert 201 comprises a number of openings 210 that are defined by two opposing sections of two adjacent first ribs 205 in the first set and two opposing sections of two adjacent second ribs 207 in the second set.

In the insert 201 according to FIG. 5 the crossing ribs 205, 207 extend over the end of the conical insert 201 having the lesser diameter. The other end thus generally acquires a convex shape.

Regarding the cross-sectional shape of the ribs 205 in the first set and the ribs 207 in the second set, it is square in the embodiment of the insert 201 shown in FIG. 5. In this context it must be pointed out that in the embodiment according to FIG. 5 the first and second sets of ribs 205 and 207, respectively, are oriented in such a way that a corner of the square is turned outward, i.e. a pointed longitudinal edge of each and every one of the linear first ribs 205 and a pointed circumferential edge of each and every one of the annular second ribs 207 impart to the insert according to the present invention important properties that will be described in greater detail below. Because these properties are the same as in the embodiment according to FIG. 1, please refer to the description associated with that embodiment with regard to the function of the insert 201.

An annular collar 11 that performs an important function in connection with the mounting of the insert 201 in a feeding bottle F is arranged at the end of the insert 1 [sic] having the greater diameter. Because the collars 11 in the embodiments according to FIGS. 1 and 5 are identical in principle, they have been assigned the same reference designation.

FIG. 6 shows a fourth embodiment of an accessory according to the present invention, wherein the accessory consists of a generally conical insert 301. As FIG. 6 shows, the envelope surface 303 of the insert 301 is defined by a conical helix, which consists of a first rib 305 that extends helically from the one end of the insert 301 to the other end of the insert 301. Adjacent portions of the first rib 305 are disposed at a distance from one another in the axial direction of the insert 301, i.e. in the direction between the ends of the insert 301. This distance is suitably of the same order of magnitude as the cross-sectional dimension of the openings in the embodiment according to FIG. 1.

Regarding the cross-sectional shape of the linear first ribs 305, it is square in the embodiment of the insert 301 shown in FIG. 6. In this context it must be pointed out that the ribs 305 in the embodiment according to FIG. 6 are oriented so that one corner of the square is turned outward, i.e. a pointed longitudinal edge of the ribs 305 imparts important properties to the insert according to the present invention. Because these properties are the same as in the embodiment according to FIG. 1, please refer to the description in connection with that embodiment with regard to the function of the insert 301.

An annular collar 11 that performs an important function in connection with the mounting of the insert 301 in a feeding bottle F is arranged at the end that has the greater diameter. Because these properties are the same in principle as in the embodiment according to FIG. 1, please refer to the description associated with that embodiment with regard to the function of the insert 301.

It may be noted by way of example and non-limitatively that the openings 10; 110; 210 can suitably have a cross-section dimension in the range of 3-8 mm.

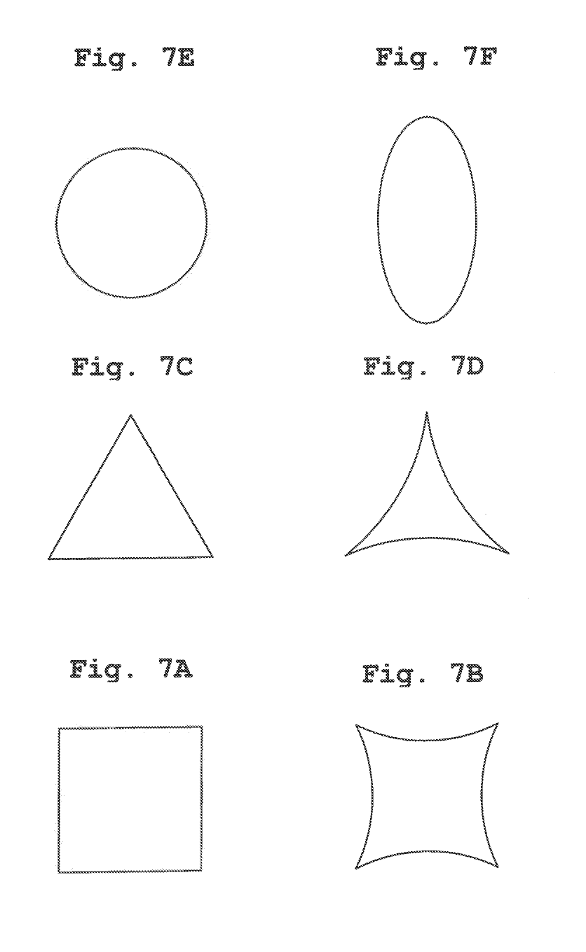

FIGS. 7A-7F show examples of cross-sections for the first and second ribs 5, 7; 105, 107; 205, 207; 305. In this context it may be noted that cross-sections beyond those exemplified in FIGS. 7A-7F can occur.

FIG. 7A shows a cross-section in the shape of square, FIG. 7B a cross-section in the shape of a tetragon with concave sides of equal length, FIG. 7C a cross-section in the shape of a triangle, FIG. 7D a cross-section in the shape of a three-corned polygon with concave sides of equal length, FIG. 7E a cross-section in the shape of a circle and FIG. 7F a cross-section in the shape of an ellipse.

The cross-sections shown in FIGS. 7A-7D have pointed corners, with “pointed corner” to be understood in this context to refer to a corner that contains an angle of 90° or less.

The cross-section shown in FIG. 7F has portions, i.e. the portions at the top and bottom, that define a smaller radius of curvature than the connected portions.

### CONCEIVABLE MODIFICATIONS OF THE INVENTION

The aforedescribed embodiment of the insert 1 is equipped with a cruciform 13 in the opening of the end having the lesser diameter. However, this cruciform could conceivably be omitted within the framework of the present invention.

The aforedescribed insert 101 can exhibit a cruciform in the opening having the lesser diameter. However, here again the cruciform could be omitted within the scope of the present invention.

1. An accessory for a feeding bottle (F), wherein the accessory consists of an insert (1; 101; 201; 301) that is generally conical and intended to be mounted in the opening of the feeding bottle (F), and wherein the envelope surface of the insert (1; 101; 201; 301) is defined by mutually crossing ribs (5, 7; 105, 107; 205, 207) that form a grid, or one rib (305) that extends helically between the ends of the insert wherein the cross section of the ribs (5, 7; 105, 107; 205, 207)/rib (305) has a pointed corner, and the pointed corner is turned outward in the envelope surface.

2. An accessory according to claim 1, wherein the cross section is square.

3. An accessory according to claim 1, wherein the cross-sections of the ribs exhibit a portion with a smaller radius of curvature than connected portions, and the portion with the smaller radius of curvature is turned outward in the envelope surface.

4. An accessory according to claim 1, wherein a first set of first ribs (5; 105) has an extension in the longitudinal direction of the insert (1; 101), and a second set of second ribs (7; 107) has an extension in the circumferential direction of the insert (1; 101), and nodes (9; 109) are defined where the first and second ribs (5;
105 and 7; 107) cross one another.

5. An accessory according to claim 1, wherein the first and second sets of first and second ribs (205, 207) extend helically between the ends of the insert (201), and the first and second sets of first and second ribs (205, 207) are twisted in opposite directions, and nodes (209) are defined where the first and second ribs (205 and 207) cross one another.

6. An accessory according to claim 1, wherein the insert (1; 101; 201; 301) has a collar (11) at the end having the greater diameter.

7. An accessory according to claim 1, wherein a cruciform (13) is arranged at the end having the lesser diameter.

8. An accessory according to claim 4, wherein the crossing ribs (5, 7; 105, 7; 205, 207) extend over the end having the lesser diameter.
